(19) United States
(12) Patent Application Publication
(10) Pub. No.: US 2002/0030155 A1
(43) Pub. Date: Mar. 14, 2002

(54) System for access monitoring of structures

(75) Inventors: Heiko Murtfeld, Garbsen (DE); Joachim Warnecke, Sachsenhagen (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 09/915,561

(22) Filed: Jul. 27, 2001

(30) Foreign Application Priority Data
Aug. 11, 2000 (DE) 100 39 273.3

(51) Int. Cl. G08B 13/06

(52) U.S. Cl. 250/227.14

(57) ABSTRACT

The invention relates to a system for access monitoring of structures, in particular cable duct systems (3), the access having a closing device (1). Access monitoring that is independent of auxiliary energy and is also suitable for remote monitoring purposes is characterized in that at least one optical fiber (6) is coupled mechanically to the closing device (1) in such a way that the optical properties of the optical fiber (6) are changeable on operation of the closing device (1).

### BACKGROUND OF THE INVENTION

The invention relates to a system for access monitoring of structures, in particular cable duct systems, the access having a closing device, wherein at least one optical fibre is coupled mechanically to the closing device in such a way that the optical properties of the optical fibre are changeable on operation of the closing device. The invention is based on a priority application (DE 100 39 273.3) which hereby incorporated by reference.

In structures of all types—from a house to a cable shaft—access monitoring systems of this kind are necessary to guarantee the security of the occupants or also the installation to the maximum extent. The most common are mechanical and electrical devices, the former only inadequately being able to fulfil the monitoring function. Electrical devices, such as electrical contacts, movement defectors, a light barrier or camera surveillance, require a power supply, which is not available in particular in the case of cable shafts or monitoring objects that are very remote from a monitoring control centre.

### SUMMARY OF THE INVENTION

The object of the invention is to specify an access monitoring system of the kind described at the beginning that manages without electrical energy and permits remote monitoring over large distances. The object is achieved by the characterizing features of claim 1. By coupling the optical fibre to the closing device, the possibility arises of monitoring the optical properties of the optical fibre from an external control centre, for example, a change taking place in the optical properties in the event that the closing device is operated.

No electrical auxiliary energy is required at the location of the closing device for this purpose. Furthermore, optical fibres can be laid as a transmission medium for monitoring functions even at very large distances of over 100 kilometers. In the case of cable systems, the existing cable shafts can be used for this. Since ever greater data flows are transported via optical cables, the operators of cable systems have a strong interest in monitoring access to the shaft structures of their cable systems, to prevent erroneous intrusions into the cable network or even sabotage attacks. The operator of the cable dud system can detect the opening of a manhole cover immediately by way of a suitable monitoring system and take suitable measures to minimize damage. Such a measure could consist in diverting the data flows in the event of unauthorized opening of a manhole cover immediately to alternative routes, to prevent a data loss. The access monitoring system claimed thus serves not only to safeguard the cable duct system against outside access, but also to increase the reliability of the system as a whole.

The attenuation of the optical fibre at the pertinent coupling point is used as an indicator of opening of the closing device. The type of the mechanical coupling between the optical fibre and the closing device is preferably realized in such a manner that an increase in attenuation occurs on opening. This increase in attenuation can be used with the aid of a suitable monitoring system to trigger an alarm in a monitoring control centre. Since monitoring systems are capable also of ascertaining the position of the attenuation increase, the opened shaft can be established and located in the minimum of time with the help of location plans.

In an advantageous form of embodiment of the coupling between the optical fibre and the closing device, the optical fibre being turned on rotation of a closing cylinder sheath of the closing device and finally being pulled in such a manner that the attenuation of the optical fibre increases at the coupling point.

Influencing of the fibre attenuation on opening of the shaft can be determined exactly according to claim 4 by means of an attenuator. In this form of embodiment also, a rotatable sheath of the closing device can be used to trigger the change in attenuation, as is clear from claim 5.

It is provided that the extent of the change in attenuation is prescribed specific to the coupling point. In the distortion variant of claims 2 and 3, the type of fastening of the optical fibre to the closing device could be designed accordingly differently, while in the case of the attenuator variant in claims 4 and 5, precise grading of the change in attenuation is possible due to the use of differently dimensioned attenuators.

Classification of the various cable shaft openings into hazard classes can be realized in this way, for example. Simple location support is also yielded.

It is provided that the optical properties of the optical fibre can be changed by an optical switch acted upon by the closing device. A switch of this kind interrupts the transmission route at the moment the closing device is opened. The signal thus generated can be evaluated in the receiving station easily and very clearly. However, in the event of a fault, monitoring of the system parts lying behind the switch is no longer guaranteed or is only possible from the other route side by optical reflection measurement. A second parting of the transmission route then inevitably leads to disconnection of the route section from the monitoring facility.

In a preferred form of performance, the optical fibre is formed as an optical fibre cable, i.e. with a covering to protect against kinking and rodents.

### BRIEF DESCRIPTION OF THE DRAWINGS

The invention is described in greater detail below with reference to figures.

FIG. 1 shows a closing system of an enlarged structure with integral waveguide and

FIGS. 1a and 1b show the functional principle of access monitoring using the closing device according to FIG. 1.

FIG. 1 illustrates the functional principle of a conventional closing device 1 of a manhole cover 2, which permits access to a cable duct system 3. The closing device 1 comprises a closing cylinder 4 with a rotatable sheath 5. To unlock the manhole cover 2, the sheath 5 is rotated roughly 90 degrees by means of a socket wrench. Attached also rotatably to the free end of the sheath 5 is an optical fibre 6. When the manhole cover 2 is unlocked, the optical fibre 6 is bent around two bolts 7a and 7b that are stationary relative to the sheath 5, resulting in an increase in the optical attenuation of the fibres. The increase in attenuation is recognized as an indication of manhole cover unlocking in a monitoring control centre. The monitoring control centre is located quasi at the end of the optical fibre 6, it being possible to connect several manhole covers 2 to one optical fibre 6 and for the distances to be covered to be more than 100 km.

FIGS. 1a and 1b clarify the position of the optical fibre 6 when the manhole cover 2 is closed (FIG. 1a) and when the manhole cover 2 is unlocked (FIG. 1b). It is apparent that on rotation of the sheath 5, fibre distortion occurs in the optical fibre 6, which changes the attenuation property of the optical fibre 6.

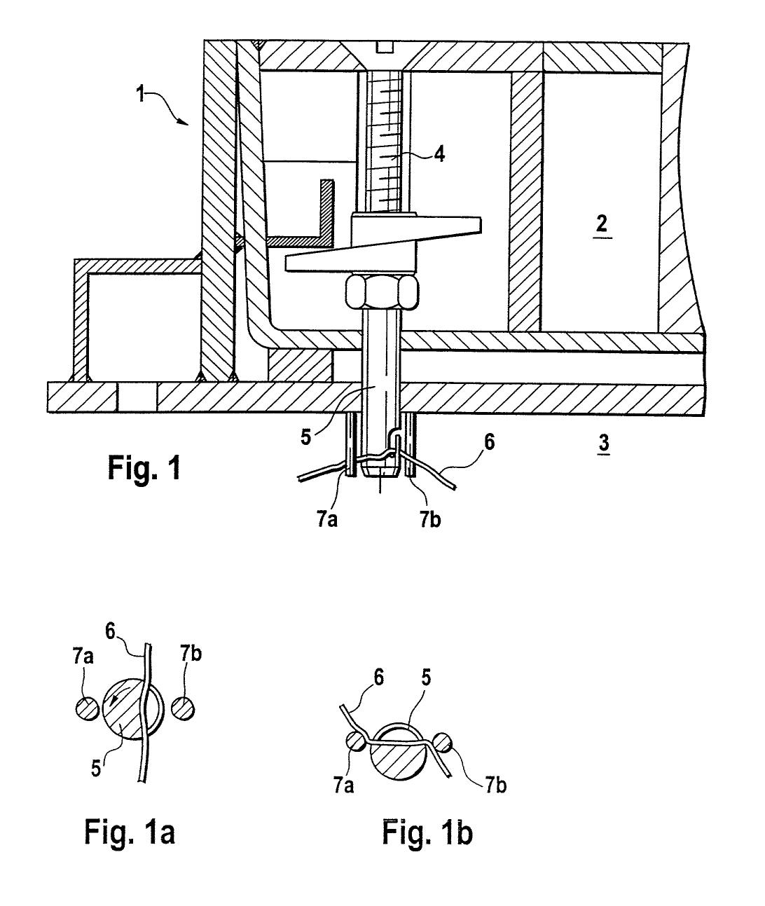

The invention is not restricted to the practical example indicated here. On the contrary, a number of variants is conceivable, which make use of the features of the invention even in a fundamentally different execution. In particular, the invention is not restricted to use for the access monitoring of cable duct systems 3.

1. System for access monitoring of structures, in particular cable duct systems, the access having a closing device, wherein at least one optical fibre is coupled mechanically to the closing device in such a way that the optical properties of the optical fibre are changeable on operation of the closing device.

2. System according to claim 1, wherein the optical fibre is coupled to the closing device in such a way that the attenuation of the optical fibre can be changed.

3. System according to claim 2, wherein the closing device has a closing cylinder with a sheath that is rotatable, in particular by means of a socket wrench, the optical fibre being connected to the sheath and being bent on rotation of the sheath around at least one bolt that does not also rotate.

4. System according to claim 2, wherein the attenuation is changeable by means of an attenuator.

5. System according to claim 4, wherein the closing device has a closing cylinder with a sheath that is rotatable, in particular by means of a socket wrench, the attenuator being connected to the sheath and causing a change in attenuation in the optical fibre when the sheath is rotated.

6. System according to any of claims, wherein the extent of the change in attenuation is prescribed specific to the coupling point.

7. System according to claim 1, wherein the optical fibre has an optical switch that is acted upon by the closing device.

8. System according to claim 1, wherein the optical fibre is formed as an optical fibre cable.
